(19) United States
(12) Patent Application Publication
(10) Pub. No.: US 2016/0086056 A1
(43) Pub. Date: Mar. 24, 2016

(54) SYSTEMS AND METHODS FOR RECOGNIZING ALPHANUMERIC CHARACTERS

(71) Applicant: Wipro Limited, Bangalore (IN)

(72) Inventors: Raghavendra Hosabettu, Bangalore (IN); Anil Kumar Lenka, Bangalore (IN)

(21) Appl. No.: 14/558,312

(22) Filed: Dec. 2, 2014

(30) Foreign Application Priority Data
Sep. 22, 2014 (IN) 4586/CHE/2014

(51) Int. Cl. G06K 9/62; G06K 9/44; G06K 9/56; G06K 9/20

(52) U.S. Cl. CPC G06K 9/6292; G06K 9/2054; G06K 9/44; G06K 9/56; G06K 2209/01

(57) ABSTRACT

Systems and methods for recognizing alphanumeric characters are described. In one implementation, the method for recognizing alphanumeric characters comprises receiving features for each of the alphanumeric characters to be recognized. The features comprises at least one of number of lines, length of lines, number of arcs, length of arcs, number of loops, length of loops, number of junctions, junction positions, or total length of lines, arcs, and loops. Further, the method comprises creating a vector for each of the alphanumeric characters based on the features. Further, the method comprises comparing the vector with a reference vector obtained from a reference database. Further, the method comprises determining an array of probabilities for each of the alphanumeric characters based on the comparison. Further, the method comprises recognizing the alphanumeric characters based on the array of probabilities.

This application claims the benefit of Indian Patent Application No. 4586/CHE/2014 filed Sep. 22, 2014, which is hereby incorporated by reference in its entirety.

### TECHNICAL FIELD

The present subject matter relates to character recognition, and, particularly but not exclusively, to systems and methods for recognizing alphanumeric characters.

### BACKGROUND

Character recognition systems are being used in various operations, such as number-plate recognition, credit/debit card recognition, smart card processing, bank cheque/demand draft processing, and address code recognition. In an example, for recognizing alphanumeric characters written or printed on business cards or credit/debit cards, images are captured and then processed to recognize each of the alphanumeric characters. Since, in such cases, typing is not needed, making payments through the cards or reading and storing information becomes much easier for user. In this manner, the character recognition systems improve overall efficiency, productivity of operations and reduce human errors by automating recognition of information.

### SUMMARY

Disclosed herein are systems and methods for recognizing alphanumeric characters. In one example, the system, for recognizing alphanumeric characters comprises a processor, a memory communicatively coupled to the processor, wherein the memory stores processor-executable instructions, which, on execution, cause the processor to receive features for each of the alphanumeric characters to be recognized. The features comprises at least one of number of lines, length of lines, number of arcs, length of arcs, number of loops, length of loops, number of junctions, junction positions, or total length of lines, arcs, and loops. The processor-executable instructions, on execution, further cause the processor to create a vector for each of the alphanumeric characters based on the features. The processor-executable instructions, on execution, further cause the processor to compare the vector with a reference vector obtained from a reference database. The processor-executable instructions, on execution, further cause the processor determine an array of probabilities for each of the alphanumeric characters based on the comparison. The processor-executable instructions, on execution, further cause the processor to recognize the alphanumeric characters based on the array of probabilities.

Certain embodiments of the present disclosure relates to a method for recognizing alphanumeric characters comprises receiving features for each of the alphanumeric characters to be recognized. The features comprises at least one of number of lines, length of lines, number of arcs, length of arcs, number of loops, length of loops, number of junctions, junction positions, or total length of lines, arcs, and loops. Further, the method comprises creating a vector for each of the alphanumeric characters based on the features. Further, the method comprises comparing the vector with a reference vector obtained from a reference database. Further, the method comprises determining an array of probabilities for each of the alphanumeric characters based on the comparison. Further, the method comprises recognizing the alphanumeric characters based on the array of probabilities.

Certain embodiments of the present disclosure also relate to a non-transitory, computer-readable medium storing instructions that, when executed by a processor, cause the processor to perform operations comprising receiving features for each of the alphanumeric characters to be recognized. The features comprises at least one of number of lines, length of lines, number of arcs, length of arcs, number of loops, length of loops, number of junctions, junction positions, or total length of lines, arcs, and loops. The memory requirements indicate memory space needed for executing the application. Further, the operations creating a vector for each of the alphanumeric characters based on the features. Further, the operations comprise comparing the vector with a reference vector obtained from a reference database. Further, the operations comprise determining an array of probabilities for each of the alphanumeric characters based on the comparison. Further, the operations comprise recognizing the alphanumeric characters based on the array of probabilities.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary network environment incorporating a recognition system, in accordance with some embodiments of the present disclosure.

FIG. 2 illustrate an exemplary computer implemented method for recognizing alphanumeric characters, in accordance with some embodiments of the present disclosure.

FIG. 3 is a block diagram of an exemplary computer system for implementing embodiments consistent with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The present subject matter discloses systems and methods for recognizing alphanumeric characters. The systems and methods may be implemented in a variety of computing systems. The computing systems that can implement the described method(s) include, but are not limited to a server, a desktop personal computer, a notebook or a portable computer, and a mainframe computer. Although the description herein is with reference to certain computing systems, the systems and methods may be implemented in other computing systems, albeit with a few variations, as will be understood by a person skilled in the art.

In operations, to recognize information available on a card, at least one image of the card may be captured. The images may be then processed to obtain a skeletonized image for feature extraction. Subsequently, structural properties of alphabets may be extracted from the skeletonized image. In an example, features, such as number of lines, length of lines, number of arcs, length of arcs, number of loops, length of loops, number of junctions, junction positions, or total length of lines, arcs, and loops in each of the alphabets present on the card may be extracted.

The extracted features are then used for creating a vector for each of the alphabets. These vectors are compared with reference vectors obtained from a reference database. The reference database comprises a reference vector for known characters, such as alphabets, numeric, and special characters. Based on the comparison, an array of probabilities is determined. Thereafter, based on the array of probabilities, the character is recognized. For example, if probability for a particular character exceeds a predefined threshold value, then it is identified that the vector corresponds to that particular character. Similarly, other characters are identified to read the information present on the card.

Thus, the present subject matter reads or recognizes the information present on the card. Since, the present subject matter considers structural properties of the character and employs vector comparison, accuracy and speed of character recognition are significantly improved, which in turn improves the overall efficiency of the character recognition.

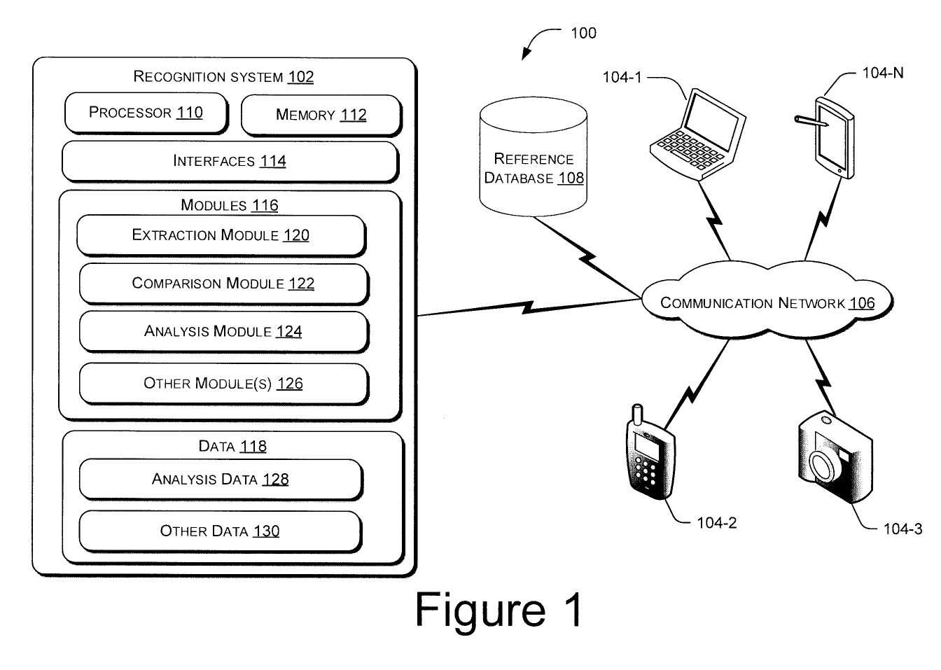

Working of the systems and methods for recognizing alphanumeric characters is described in conjunction with FIGS. 1-3. It should be noted that the description and drawings merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and are to be construed as being without limitation to such specifically recited examples and conditions. Moreover, all statements herein reciting principles, aspects, and embodiments of the present subject matter, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates a network environment 100 incorporating a recognition system 102 for recognizing alphanumeric characters, according to some embodiments of the present disclosure.

The recognition system 102, hereinafter referred to as system 102, may be implemented in a variety of computing systems, such as a laptop computer, a desktop computer, a notebook, a workstation, a mainframe computer, a server, a network server, and the like. Further, as shown in FIG. 1, the plurality of devices 104-1, 104-2, 104-3, 104-N are communicatively coupled to each other and to the system 102 through a network 106 for facilitating one or more end users to access and/or operate the system 102. The plurality of devices 104-1, 104-2, 104-3, 104-N, collectively referred to as devices 104 and individually referred to as device 104. In an example, each of the devices 104 may have image capturing capabilities. Examples of the devices 104 include, but are not limited to, a desktop computer, a portable computer, a server, a handheld device, a mobile phone, a camera, and a workstation. The devices 104 may be used by a user to capture images of an object from where information is to be recognized. In an example, the object may be credit/debit cards, business cards, number-plates, identification cards, cheques, and demand drafts. In one implementation, the system 102 may be implemented or configured in at least one of the devices 104 to recognize alphanumeric characters present on the object.

The network 106 may be a wireless network, wired network or a combination thereof. The network 106 can be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 106 may include a variety of network devices, including routers, bridges, servers, computing devices, storage devices, etc.

Further, as shown in FIG. 1, the system 102 and the devices 104 are communicatively coupled to a reference database 108 through the network 106. The reference database 108 comprises a reference vector for each of known characters, such as alphabets, numeric, and special characters. The reference vector provides details about structural properties of a character. For example, the reference vector for an alphabet ‘T’ may indicate features or properties such as number of lines, length of lines, number of arcs, length of arcs, number of loops, length of loops, number of junctions, junction positions, or total length of lines, arcs, and loops in the alphabet ‘T’. In one implementation, reference vectors for the characters may be stored within the system 102.

The system 102 may include a processor 110, a memory 112 coupled to the processor 110, and interface(s) 114. The processor 110 may be implemented as one or more microprocessors, microcomputers, microcontrollers, digital signal processors, central processing units, state machines, logic circuitries, and/or any devices that manipulate signals based on operational instructions. Among other capabilities, the processor 110 is configured to fetch and execute computer-readable instructions stored in the memory 112. The memory 112 can include any non-transitory computer-readable medium known in the art including, for example, volatile memory (e.g., RAM), and/or non-volatile memory (e.g., EPROM, flash memory, etc.).

The interface(s) 114 may include a variety of software and hardware interfaces, for example, a web interface, a graphical user interface, etc., allowing the system 102 to interact with the devices 104. Further, the interface(s) 114 may enable the system 102 respectively to communicate with other computing devices. The interface(s) 114 can facilitate multiple communications within a wide variety of networks and protocol types, including wired networks, for example LAN, cable, etc., and wireless networks such as WLAN, cellular, or satellite. The interface(s) 114 may include one or more ports for connecting a number of devices to each other or to another server.

In one example, the system 102 includes modules 116 and data 118. In one embodiment, the modules 116 and the data 118 may be stored within the memory 112. In one example, the modules 116, amongst other things, include routines, programs, objects, components, and data structures, which perform particular tasks or implement particular abstract data types. The modules 116 and may also be implemented as, signal processor(s), state machine(s), logic circuitries, and/or any other device or component that manipulate signals based on operational instructions. Further, the modules 116 can be implemented by one or more hardware components, by computer-readable instructions executed by a processing unit, or by a combination thereof.

As shown in FIG. 1, the modules 116 further include an extraction module 120, a comparison module 122, an analysis module 124, and other module(s) 126. It will be appreciated that such aforementioned modules may be represented as a single module or a combination of different modules.

In one example, the data 118 serves, amongst other things, as a repository for storing data fetched, processed, received and generated by one or more of the modules 116. In one implementation, the data 118 may include, for example, analysis data 128 and other data 130. In one embodiment, the data 118 may be stored in the memory 112 in the form of various data structures. Additionally, the aforementioned data can be organized using data models, such as relational or hierarchical data models. The other data 130 may be used to store data, including temporary data and temporary files, generated by the modules 116 for performing the various functions of the system 102.

In operation, to recognize alphanumeric characters printed/written on the object, such as cards, the extraction module 120 may receive at least one image of the object captured through the device 104. In an example, if captured image doesn't meet predefined requirements, such as resolution and size, then the extraction module 120 may instruct the device 104 to capture the image of the object again. Once the image meets the predefined requirements, the extraction module 120 may consider the image for preprocessing.

In preprocessing, the extraction module 120 may perform various operations on the image so that the image is ready for character recognition. In an example, the extraction module 120 may apply various techniques, such as threshold to remove noise from the image. Further, in case the image is in RGB format, the extraction module 120 may convert the image into a grayscale image for further processing. The extraction module 120 may also perform a skew/slant correction on the image to obtain the image in a desired orientation which is well-suited for the character recognition. Further, to detect borders of the object, such as card, the extraction module 120 may apply Canny or Sobel operator to the processed image to detect edges on the image. Thereafter, the extraction module 120 may extract all contours and find a largest area contour which is the actual borders of the card. Further, the extraction module 120 may detect orientation of the Image using bounding box concept and crop the image to extract area corresponding to the card.

Once the area corresponding to the card is extracted, the extraction module 120 may perform character localizing to identify location where the characters are present on the card. The extraction module 120 may extract image parts comprising the characters. For greater accuracy, the extraction module 120 may extract every character exactly to its border so that each of the characters is clearly distinguished.

The extraction module 120 may then perform segmentation with help of an experimentally determined value. In an example, the user may provide the experimentally determined value using one of the devices 104. Subsequently, every pixel with a value higher than the experimentally determined value becomes white and every pixel with a value lower than the experimentally determined value becomes black. In this manner, the grayscale image is converted into a binary image with two possible pixel values, black (0) and white (1). Since the binary image is made of two contrasting colors, characters on the image remain. The extraction module 120 may determine horizontal boundaries between segmented characters by computing a horizontal projection on the binary image. The horizontal boundaries correspond to peaks in the graph of the horizontal projection. In this manner, peaks that correspond to the spaces between characters are identified. Thereafter, the extraction module 120 may extract the alphanumeric characters using vertical segments from horizontal segment portions. In an example, the horizontal segment portions are determined based on the horizontal boundaries. The extraction module 120 divides the horizontal segment portions vertically into the several pieces, using principle of a ‘seed-fill’ algorithm and keeps only one piece representing an alphanumeric character. Further, the extraction module 120 eliminates unused pieces from the alphanumeric characters pieces present in the horizontal segment portions and extracts the alphanumeric character.

Then, the extraction module 120 may perform skeletonization to obtain a skeletonized image. In the skeletonization, the extraction module 120 may normalize dimensions of the alphanumeric characters and resample the alphanumeric characters using a Nearest-neighbor or weighted-average method of down sampling. Subsequently, the extraction module 120 extracts appropriate descriptors from the normalized alphanumeric characters. Further, the extraction module 120 may extract a region-based shape feature representing general form of an alphanumeric character. In this manner, the skeletonized image, of the alphanumeric characters to be recognized, is obtained.

Once the skeletonized image is obtained, the extraction module 120 may extract features of each of the alphanumeric characters present in the skeletonized image. In an example, the features may include number of lines, length of lines, number of arcs, length of arcs, number of loops, length of loops, number of junctions, junction positions, or total length of lines, arcs, and loops.

Further, the extraction module 120 may create a vector for each of the alphanumeric characters. The vector for a particular character may indicate the features that particular character has. For example, a vector for numeric ‘8’ may indicate that the character has two loops and one junction. Similarly, the vector is determined for each of the characters with the features the characters have.

Upon determining the vector for each of the alphanumeric characters, a reference vector for each of known characters may be obtained from the reference database 108. The known characters may include alphabets, numeric, and special characters for which features are already know and stored in the reference database 108. In an example, the features are associated with the characters through the reference vector. Each of the characters has a unique reference code indicating features or structural properties of the character.

In an example, the reference database 108 may be created by collecting all 10 digits, 26 alphabets in capitals, 26 alphabets in small letters, and special characters having same font type used in cards. Images of these characters may be processed as explained above to obtain skeletonized images for feature extraction. Subsequently, the features, such as number of lines, total lines length, number of arcs, total arcs length, number of loops, total loops length, number of junctions, junction's position and total length (lines, arcs, loops) of all 10 (0, 1, . . . 9) digits, 26 capitals (A, B, . . . Z) letters, 26 small (a, b, . . . z) letters and special characters are identified. Further, the reference vector for each of the characters is created and stored in the reference database 108. It may be noted that the reference vector is unique for each of the characters.

Once the reference vectors are obtained, the comparison module 122 may compare the vector with the reference vectors to determine an array of probabilities for each of the alphanumeric characters. The array of probabilities may indicate resemblance of identified character to a known character. Thereafter, the analysis module 124 may recognize the alphanumeric character based on the array of probabilities. Similarly, other alphanumeric characters are identified and whole information present on the card is recognized. In an example, the analysis module 124 may compare the array of probabilities, for a particular alphanumeric character, with a predefined threshold value. In case, the probability for a known alphanumeric character is higher than the predefined threshold value, then the analysis module 124 recognized that particular alphanumeric character as the known alphanumeric character. For example, probability for an alphanumeric character to be ‘X’ is 0.99 which is higher than the predefined threshold value of 0.9, then the analysis module 124 may recognize the alphanumeric character as ‘X’. In case, the probability is lower than the predefined threshold value, then the analysis module 124 may discard the suggested alphanumeric character and look for other alphanumeric characters. In an example, the predefined threshold value may be determined based on user input obtained through one of the devices 104. Further, the analysis module 124 may store the predefined threshold value and all relevant results, such as the array of probabilities and recognized characters in the analysis data 128.

Upon recognizing all the alphanumeric characters, the analysis module 124 may combine the alphanumeric characters in order and send it to systems that require to process this information in order to complete various operations, such as number-plate recognition, credit/debit card recognition, smart card processing, bank cheque/demand draft processing, and address code recognition.

Further, below are some examples to illustrate that the system 102 may easily distinguish the alphanumeric characters with similar shape.

In case of characters ‘b’ and ‘d’, the number of lines, junctions and loops are same but the junction positions are different.

In case of characters ‘6’ and ‘9’ or ‘7’ and ‘L’, the number of arc, loop and junction are same but the position of junction is different.

In case of characters ‘0’ and ‘o’, most of the features are same except the total length.

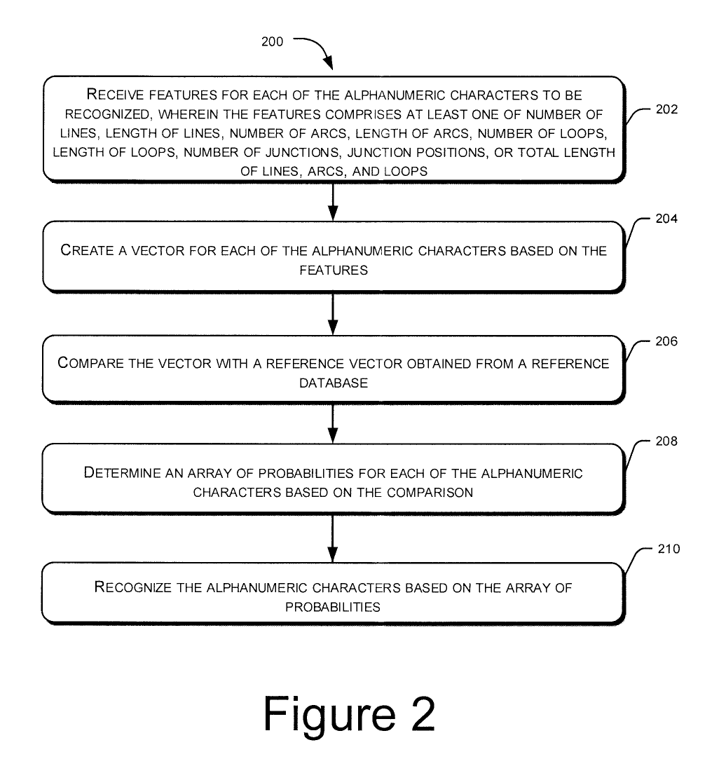

FIG. 2 illustrates exemplary computer implemented methods for recognizing alphanumeric characters, according to some embodiments of the present disclosure.

The methods 200 may be described in the general context of computer executable instructions. Generally, computer executable instructions can include routines, programs, objects, components, data structures, procedures, modules, and functions, which perform particular functions or implement particular abstract data types. The methods 200 may also be practiced in a distributed computing environment where functions are performed by remote processing devices that are linked through a communication network. In a distributed computing environment, computer executable instructions may be located in both local and remote computer storage media, including memory storage devices.

The order in which the method 200 is described is not intended to be construed as a limitation, and any number of the described method blocks can be combined in any order to implement the method 200 or alternative methods. Additionally, individual blocks may be deleted from the method 200 without departing from the spirit and scope of the subject matter described herein. Furthermore, the method 200 can be implemented in any suitable hardware, software, firmware, or combination thereof.

With reference to method 200 as depicted in FIG. 2, as shown in block 202, features, for each of the alphanumeric characters to be recognized, are received. Examples of the features may comprise number of lines, length of lines, number of arcs, length of arcs, number of loops, length of loops, number of junctions, junction positions, and total length of lines, arcs, and loops. In one example, the extraction module 120 may receive at least one image of a card from where the alphanumeric cards are to be recognized. The extraction module 120 may instruct the device 104 to capture the image and send to the extraction module 120 for processing and further processes. The captures image may be then processed by the extraction module 120 and a skeletonized image is obtained for feature extraction. Thereafter, the features may be extracted from the skeletonized image and obtained by the extraction module 120.

At block 204, a vector is created for each of the alphanumeric characters based on the features. In an example, the extraction module 120 may combine all the features corresponding to each of the alphanumeric characters and create the vector for comparison. The vector may indicate the features and values associated with the features for a particular alphanumeric character.

At block 206, the vector is compared with a reference vector, obtained from a reference database 108, for each of the alphanumeric characters. In an example, the comparison module 122 may obtain the reference vector from the reference database 108 and compare with the vector for each of the alphanumeric characters. In another example, the reference vectors may be present within the system 102 in the analysis data 128. In such cases, the comparison module 122 may obtain the reference vectors from the analysis data 128.

At block 208, an array of probabilities is determined for each of the alphanumeric characters based on the comparison. In one example, the comparison module 122 may determine the array of probabilities. The array of probabilities may indicate degree of similarity between the alphanumeric character recognized and known alphanumeric characters. In an example, the probabilities may be depicted in percentage. For example, 90% is probability is there that the alphanumeric character is ‘Z’.

At block 210, the alphanumeric characters are recognized based on the array of probabilities. In one example, the analysis module 124 may recognize the alphanumeric characters based on the array of probabilities. Further, to recognize the alphanumeric characters, the analysis module 124 may evaluate whether the probability for an alphanumeric character is higher than a predefined threshold or not. In this manner, the alphanumeric characters having the probability higher than the predefined threshold value are recognized and the alphanumeric characters with probability lower than the predefined threshold value are discarded.

### Computer System

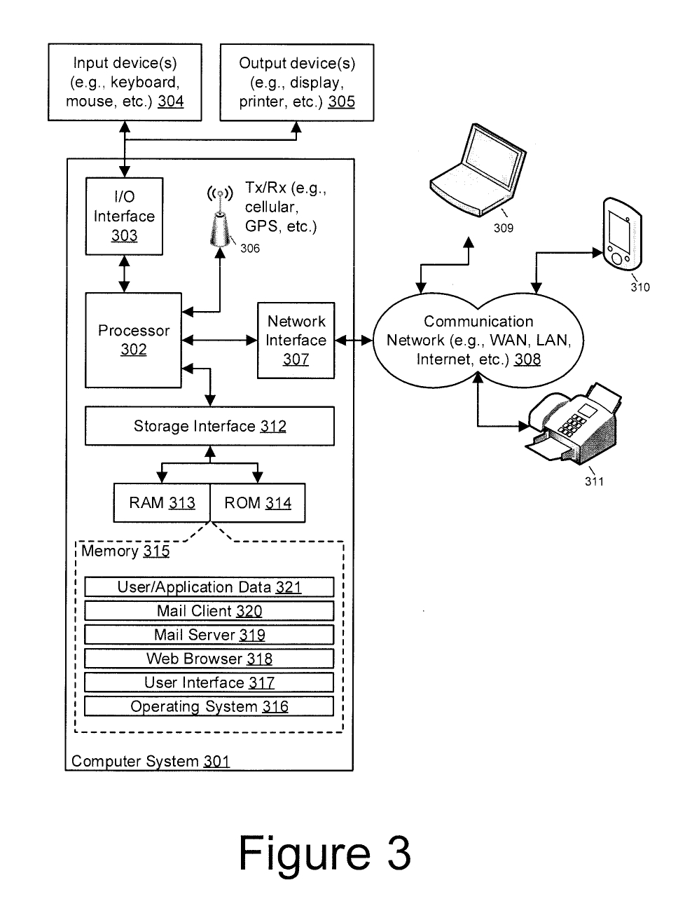

FIG. 3 is a block diagram of an exemplary computer system for implementing embodiments consistent with the present disclosure. Variations of computer system 301 may be used for implementing any of the devices presented in this disclosure. Computer system 301 may comprise a central processing unit (“CPU” or “processor”) 302. Processor 302 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 302 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 302 may be disposed in communication with one or more input/output (I/O) devices via I/O interface 303. The I/O interface 303 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 303, the computer system 301 may communicate with one or more I/O devices. For example, the input device 304 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 305 may be a printer, fax machine, video display (e.g., cathode ray tube (CRT), liquid crystal display (LCD), light-emitting diode (LED), plasma, or the like), audio speaker, etc. In some embodiments, a transceiver 306 may be disposed in connection with the processor 302. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 302 may be disposed in communication with a communication network 308 via a network interface 307. The network interface 307 may communicate with the communication network 308. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 308 may include, without limitation, a direct interconnection, local area network (LAN), wide area network (WAN), wireless network (e.g., using Wireless Application Protocol), the Internet, etc. Using the network interface 307 and the communication network 308, the computer system 301 may communicate with devices 310, 311, and 312. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 301 may itself embody one or more of these devices.

In some embodiments, the processor 302 may be disposed in communication with one or more memory devices (e.g., RAM 313, ROM 314, etc.) via a storage interface 312. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 316, user interface application 317, web browser 318, mail server 319, mail client 320, user/application data 321 (e.g., any data variables or data records discussed in this disclosure), etc. The operating system 316 may facilitate resource management and operation of the computer system 301. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 317 may facilitate display, execution, interaction, manipulation, or operation of program components through textual or graphical facilities. For example, user interfaces may provide computer interaction interface elements on a display system operatively connected to the computer system 301, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 301 may implement a web browser 318 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 301 may implement a mail server 319 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 301 may implement a mail client 320 stored program component. The mail client may be a mail viewing application, such as Apple Mail, Microsoft Entourage, Microsoft Outlook, Mozilla Thunderbird, etc.

In some embodiments, computer system 301 may store user/application data 321, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described systems and methods for recognizing alphanumeric characters. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A method for alphanumeric character recognition, the method comprising:
obtaining, by a recognition computing device, a plurality of features for each of a plurality of unrecognized alphanumeric characters, wherein the features comprise a number of lines, length of lines, number of arcs, length of arcs, number of loops, length of loops, number of junctions, junction positions, or total length of lines, arcs, or loops;
creating, by the recognition computing device, a vector for each of the unrecognized alphanumeric characters based on the plurality of features without segmenting the unrecognized alphanumeric characters, wherein each of the vectors comprises a value for each of the plurality of features;
comparing, by the recognition computing device, each of the vectors comprising the value for each of the plurality of features with one or more reference vectors obtained from a reference database, wherein each of the reference vectors corresponds to one of a plurality of known alphanumeric characters;
determining, by the recognition computing device, an array of probabilities for each of the unrecognized alphanumeric characters based on the comparison, the array of probabilities comprising a likelihood that each of the unrecognized alphanumeric characters corresponds to each of the known alphanumeric characters; and
generating, by the recognition computing device, a result based on the array of probabilities for each of the unrecognized alphanumeric characters, the result comprising an indication of one of the known alphanumeric characters for each of the unrecognized alphanumeric characters.

2. The method of claim 1, wherein the generating further comprises:
determining when a probability in the array of probabilities for each of the unrecognized alphanumeric characters is greater than a predefined threshold value; and
outputting the indication of the one of the known alphanumeric characters corresponding to the probability for each of the unrecognized alphanumeric characters, when the determining indicates that the probability is greater than the predefined threshold value.

3. The method of claim 1, wherein the reference vector comprises a number of lines, length of lines, number of arcs, length of arcs, number of loops, length of loops, number of junctions, junction positions, or total length of lines, arcs, or loops for each of the known alphanumeric characters.

4. The method of claim 1, wherein each of the reference vectors is unique for each of the known alphanumeric characters.

5. (canceled)

6. The method of claim 1, wherein the obtaining further comprises:
capturing an image comprising the unrecognized alphanumeric characters;
pre-processing the image to obtain a skeletonized image; and
extracting the plurality of features for each of the unrecognized alphanumeric characters from the skeletonized image.

7. A recognition computing device, the recognition computing device comprising:
a processor coupled to a memory, wherein the processor is configured to execute instructions stored in the memory device to perform operations comprising:
obtaining a plurality of features for each of a plurality of unrecognized alphanumeric characters, wherein the features comprise a number of lines, length of lines, number of arcs, length of arcs, number of loops, length of loops, number of junctions, junction positions, or total length of lines, arcs, or loops;
creating a vector for each of the unrecognized alphanumeric characters based on the plurality of features without segmenting the unrecognized alphanumeric characters, wherein each of the vectors comprises a value for each of the plurality of features;
comparing each of the vectors comprising the value for each of the plurality of features with one or more reference vectors obtained from a reference database, wherein each of the reference vectors corresponds to one of a plurality of known alphanumeric characters;
determining an array of probabilities for each of the unrecognized alphanumeric characters based on the comparison, the array of probabilities comprising a likelihood that each of the unrecognized alphanumeric characters corresponds to each of the known alphanumeric characters; and
generating a result based on the array of probabilities for each of the unrecognized alphanumeric characters, the result comprising an indication of one of the known alphanumeric characters for each of the unrecognized alphanumeric characters.

8. The recognition computing device of claim 7, wherein the generating further comprises:
determining when a probability in the array of probabilities for each of the unrecognized alphanumeric characters is greater than a predefined threshold value; and
outputting the indication of the one of the known alphanumeric characters corresponding to the probability for each of the unrecognized alphanumeric characters, when the determining indicates that the probability is greater than the predefined threshold value.

9. The recognition computing device of claim 7, wherein the reference vector comprises a number of lines, length of lines, number of arcs, length of arcs, number of loops, length of loops, number of junctions, junction positions, or total length of lines, arcs, or loops for each of the known alphanumeric characters.

10. The recognition computing device of claim 7, wherein each of the reference vectors is unique for each of the known alphanumeric characters.

11. (canceled)

12. The recognition computing device of claim 7, wherein the obtaining further comprises:
capturing an image comprising the unrecognized alphanumeric characters;
pre-processing the image to obtain a skeletonized image; and
extracting the plurality of features for each of the unrecognized alphanumeric characters from the skeletonized image.

13. A non-transitory computer-readable medium comprising instructions for alphanumeric character recognition that, when executed by a processor, cause the processor to perform operations comprising:
obtaining a plurality of features for each of a plurality of unrecognized alphanumeric characters, wherein the features comprise a number of lines, length of lines, number of arcs, length of arcs, number of loops, length of loops, number of junctions, junction positions, or total length of lines, arcs, or loops;
creating a vector for each of the unrecognized alphanumeric characters based on the plurality of features without segmenting the unrecognized alphanumeric characters, wherein each of the vectors comprises a value for each of the plurality of features;
comparing each of the vectors comprising the value for each of the plurality of features with one or more reference vectors obtained from a reference database, wherein each of the reference vectors corresponds to one of a plurality of known alphanumeric characters;
determining an array of probabilities for each of the unrecognized alphanumeric characters based on the comparison, the array of probabilities comprising a likelihood that each of the unrecognized alphanumeric characters corresponds to each of the known alphanumeric characters; and
generating a result based on the array of probabilities for each of the unrecognized alphanumeric characters, the result comprising an indication of one of the known alphanumeric characters for each of the unrecognized alphanumeric characters.

14. The non-transitory computer-readable medium of claim 13, wherein the generating further comprises:
determining when a probability in the array of probabilities for each of the unrecognized alphanumeric characters is greater than a predefined threshold value; and
outputting the indication of the one of the known alphanumeric characters corresponding to the probability for each of the unrecognized alphanumeric characters, when the determining indicates that the probability is greater than the predefined threshold value.

15. The non-transitory computer-readable medium of claim 13, wherein the reference vector comprises a number of lines, length of lines, number of arcs, length of arcs, number of loops, length of loops, number of junctions, junction positions, or total length of lines, arcs, or loops for each of the known alphanumeric characters.

16. The non-transitory computer-readable medium of claim 13, wherein each of the reference vectors is unique for each of the known alphanumeric characters.

17. (canceled)

18. The non-transitory computer-readable medium of claim 13, wherein the obtaining further comprises:
capturing an image comprising the unrecognized alphanumeric characters;
pre-processing the image to obtain a skeletonized image; and
extracting the plurality of features for each of the unrecognized alphanumeric characters from the skeletonized image.
